(19) United States
(12) Patent Application Publication
(10) Pub. No.: US 2008/0079990 A1
(43) Pub. Date: Apr. 3, 2008

(54) DOCUMENT PROCESSING DEVICE, DOCUMENT PROCESSING SYSTEM, AND STORAGE MEDIUM STORING A COMPUTER PROGRAM

(75) Inventor: Hiroshi IIDA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD, Tokyo (JP)

(21) Appl. No.: 11/740,327

(22) Filed: Apr. 26, 2007

(30) Foreign Application Priority Data
Sep. 28, 2006 (JP) 2006-265044

(51) Int. Cl. H04N 1/00

(52) U.S. Cl. 358/1.15

(57) ABSTRACT

A document processing device is disclosed which includes: an acquiring unit acquiring restricting information that stipulates, per user, whether execution of processing relating to a document is permitted or restricted; a converting unit converting the restricting information acquired by the acquiring unit into an optically-readable restricting information image; and an embedding unit embedding the restricting information image into information of the document, such that the restricting information image is also printed when the document is printed. Also disclosed are a document processing system including the document processing device, and a storage medium storing a computer program that causes a computer to execute functions of the aforementioned respective units.

### CROSS-REFERENCE TO RELATED APPLICATION

This application claims priority under 35 USC 9 from Japanese Patent Application No. 2006-265044 filed Sep. 28, 2006.

### BACKGROUND

1. Technical Field

The present invention relates to a document processing device, a document processing system, and a storage medium storing a document processing program.

2. Related Art

When distributing paper documents, the setting of usage restrictions per document and per user of each document has generally not been easy.

### SUMMARY

In accordance with one aspect of the present invention, there is provided a document processing device including: an acquiring unit that acquires restricting information that stipulates, per user, whether execution of processing relating to a document is permitted or restricted; a converting unit that converts the restricting information acquired by the acquiring unit into an optically-readable restricting information image; and an embedding unit that embeds the restricting information image into information of the document, such that the restricting information image is also printed when the document is printed.

### BRIEF DESCRIPTION OF THE DRAWINGS

Exemplary embodiments of the present invention will be described in detail based on the following figures, in which:

FIG. 1 is a block diagram showing the schematic structure of a computer system relating to a present exemplary embodiment;

FIG. 2 is a flowchart showing the contents of information adding processing;

FIGS. 3A through 3E are image drawings showing examples of screens which are displayed during execution of the information adding processing;

FIG. 4 is an image drawing showing an example of a document to which a two-dimensional barcode, which serves as a mark expressing restricting information, is added; and

FIG. 5 is a flowchart showing the contents of service usage control processing.

### DETAILED DESCRIPTION

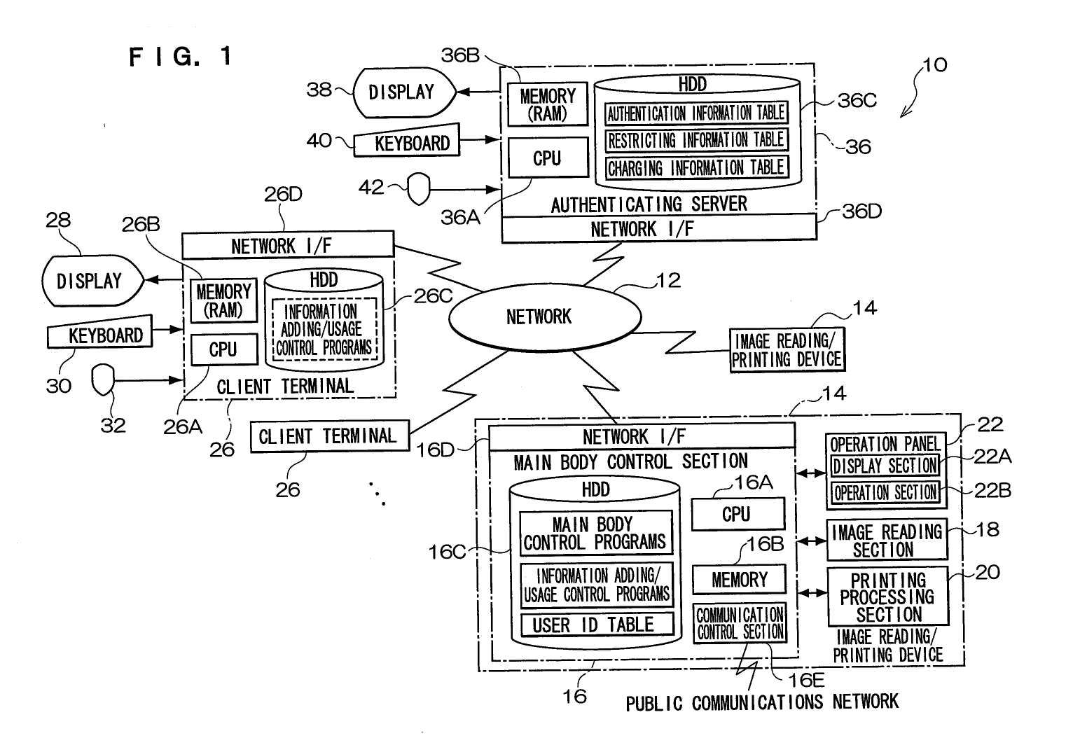

An example of an exemplary embodiment of the present invention will be described in detail hereinafter with reference to the drawings. The schematic structure of a computer system 10 relating to the present exemplary embodiment is shown in FIG. 1. The computer system 10 is structured such that one or plural image reading/printing devices 14 (a structure in which two of the image reading/printing devices 14 are provided is shown in FIG. 1), plural client terminals 26 formed from PCs (Personal Computers) or the like, and an authenticating server 36 are respectively connected to a network 12 which is formed from a LAN or the like.

The image reading/printing device 14 can be structured by a device which combines, for example, the functions of a copier, the functions of a printer, and the functions of a fax machine. The image reading/printing device 14 has a main body control section 16 which is formed from a microcomputer or the like, and which incorporates a CPU 16A, a memory 16B, an HDD (Hard Disk Drive) 16C, a network I/F (interface) section 16D, and a communication control section 16E. Further, an image reading section 18 which optically reads a set document (paper manuscript) which is the object of reading and outputs read image data, a printing processing section 20 which prints an image expressed by inputted print image data onto a recording sheet, and an operation panel 22 having a display section 22A serving as a display unit and formed from an LCD or the like and an operation section 22B serving as an inputting unit and formed from a ten-key or a touch panel or the like, are respectively connected to the main body control section 16.

The network I/F section 16D of the main body control section 16 is connected to the network 12, and governs the communications, via the network 12, with the client terminals 26 and the authenticating server 36. The communication control section 16E is connected to a public communications network (not illustrated), and governs communications, via the public communications network, with other devices which are also equipped with the functions of a fax machine. Main body control programs, which are for controlling the operations of the respective sections of the image reading/printing device 14 and providing various types of services to users (e.g., color copying and monochromatic copying, facsimile transmission, scanning (the service of reading a document and storing the data), printing, and the like of documents), and information adding/usage control programs, which are formed from a program for carrying out information adding processing and a program for carrying out service usage control processing, which will be described later, by the CPU 16A, are respectively installed in the HDD 16C of the main body control section 16 as programs which are executed by the CPU 16A. Note that, in the present exemplary embodiment, user IDs are respectively given in advance to the individual users who utilize the computer system 10, and a user ID table, in which are registered the user IDs of all of the users of the computer system 10, also is registered in the HDD 16C.

Each of the client terminals 26 has a CPU 26A, a memory 26B, an HDD 26C, and a network I/F section 26D, and is connected to the network 12 via the network I/F section 26D. A display 28, a keyboard 30, and a mouse 32 are respectively connected to the client terminal 26. Further, the program of an OS (Operating System) and programs of various types of applications are installed in the HDD 26C of the client terminal 26 (such installation is not illustrated).

Each authenticating server 36 has a CPU 36A, a memory 36B, an HDD 36C, and a network I/F section 36D, and is connected to the network 12 via the network I/F section 36D. A display 38, a keyboard 40, and a mouse 42 are respectively connected to the authenticating server 36. The program of an OS (Operating System), and programs of applications for realizing the functions of the authenticating server 36, are installed in the HDD 36C of the authenticating server 36 (such installation is not illustrated). Further, an authentication information table, in which are registered the user IDs and passwords of all of the users of the computer system 10, is stored in the HDD 36C of the authenticating server 36, and further, a restricting information table and a charging information table also are stored in the HDD 36C.

As shown as an example in following Table 1, the restricting information table is structured such that restricting information which includes information (“Usable Services” in Table 1), which stipulates, among the services provided by the image reading/printing device 14, usage of which services is permitted and usage of which services is prohibited, and charge designating information (“Charge” in Table 1), which stipulates whether or not charging processing is to be carried out when a usable service is utilized, are respectively registered for all of the users of the computer system 10. Note that default values corresponding to standard usage conditions for each individual user (values which express the services for which usage is permitted and the absence/presence of execution of charging processing at times when the individual users use the image reading/printing device 14 normally) are set for the restricting information for each individual user who is registered in the restricting information table. Further, charging information, which is set per user and which is updated accompanying the execution of charging processing, is held in the charging information table.

TABLE 1
Example of Restricting Information Table
Stored in Authenticating Server

| User ID | Usable Services | Charge |
|---|---|---|
| Fuji-1 | Copy(Color/Mono)/FAX/Scan/ . . . | No |
| Fuji-2 | Copy(Color/Mono)/FAX | Yes |
| Fuji-3 | Copy(Color/Mono) | Yes |
| Fuji-4 | Copy(Color/Mono) | Yes |
| Fuji-5 | Copy(Color/Mono) | Yes |
| Xerox-1 | Copy(Color/Mono)/FAX/Scan/ . . . | No |
| Xerox-2 | Copy(Color/Mono) | Yes |
| Xerox-3 | Copy(Color/Mono)/FAX | Yes |
| Xerox-4 | Scan | Yes |
| Xerox-5 | Copy(Color/Mono) | Yes |
| . . . | . . . | . . . |

Operation of the present exemplary embodiment will be described next. Various documents circulate in the computer system 10 relating to the present exemplary embodiment. When it is desired to, for a specific document among these documents, permit/restrict, per user, the carrying out of processes such as color copying or monochromatic copying, facsimile transmission, scanning, or the like using the services which the image reading/printing device 14 provides, the image reading/printing device 14 is instructed by a specific user (e.g., the creator or administrator of the specific document or the like) to add restricting information (information for permitting/restricting, per user, processing of the specific document) to the specific document (more specifically, to add a mark expressing the restricting information). Note that there are cases in which the specific document which is the object of addition of the restricting information (hereinafter called “document for processing”) exists in a state of being printed on a recording sheet, and cases in which it is stored as data in a predetermined storage location (e.g., a specific directory within the HDD 16C of a specific client terminal 26). When the addition of restricting information to a document for processing is instructed as mentioned above, when the document for processing exists in a state of being printed on a recording sheet, the specific document in its state of being printed on a recording sheet is set by a specific user at the image reading section 18 of the image reading/printing device 14, and when the document for processing is stored as data in a predetermined storage location, the operation section 22B of the operation panel 22 is operated by a specific user, and the storage location of the data of that specific document is designated.

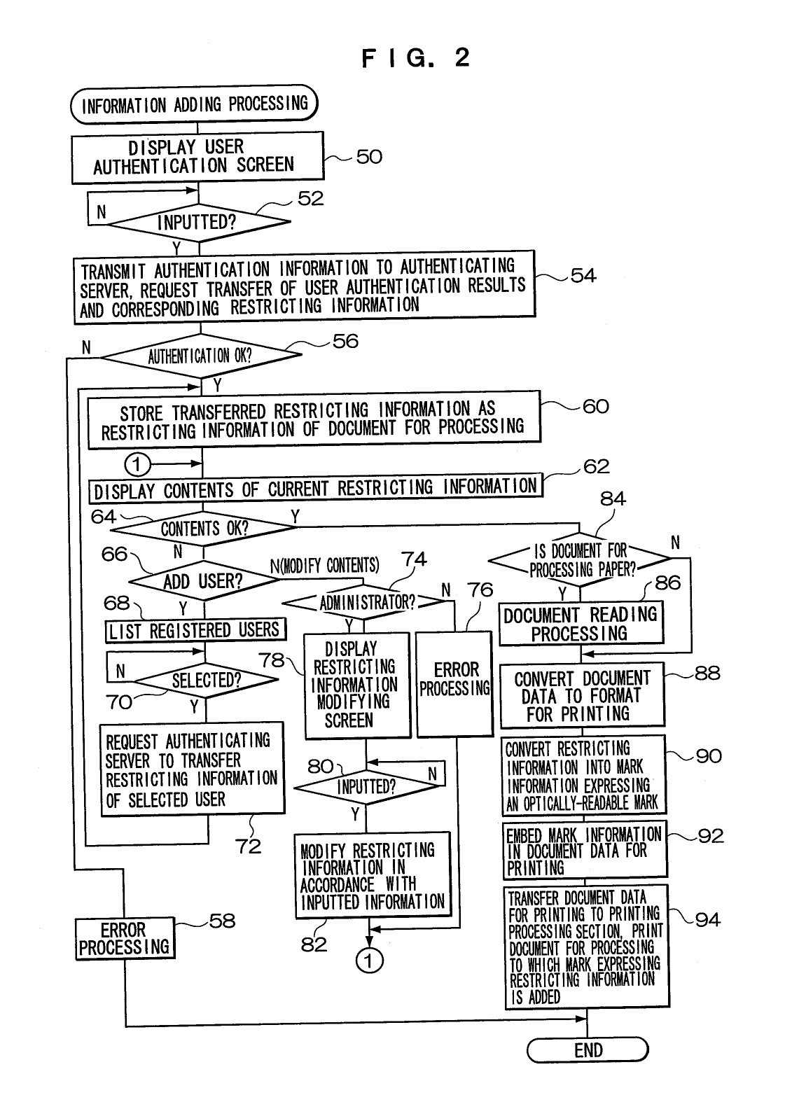

When the addition of restricting information to a document for processing is instructed as described above, the program for carrying out information adding processing, among the information adding/usage control programs, is executed by the CPU 16A of the main body control section 16 of the image reading/printing device 14. The information adding processing shown in FIG. 2 is thereby carried out by the main body control section 16.

In this information adding processing, first, in step 50, a user authentication screen, in which are provided input fields for user authentication information (the user ID and password), is displayed on the display section 22A of the operation panel 22. The specific user, who instructed the image reading/printing device 14 to add the restricting information, is thereby requested to input user authentication information. In next step 52, it is judged whether or not the user authentication information is inputted by the specific user, and step 52 is repeated until this judgment is affirmative. When the user authentication screen is displayed on the display section 22A of the operation panel 22, the specific user who instructed the addition of restricting information operates the operation section 22B of the operation panel 22 and inputs his/her own user authentication information (user ID and password). In this way, the judgment in step 52 is affirmative, and the routine moves on to step 54 where the user authentication information inputted by the specific user is transmitted to the authenticating server 36, and information, which requests the execution of authentication processing and the transfer of authentication processing results, and information, which requests the transfer of restricting information corresponding to the specific user, are also transmitted to the authenticating server 36.

When the authenticating server 36 receives the aforementioned respective information from the image reading/printing device 14, first, the authenticating server 36 carries out authentication processing, which judges whether or not the specific user operating the image reading/printing device 14 is a legitimate user, by collating the received user authentication information with information registered in the authentication information table. Here, if the combination of the user ID and the password, which is received as the user authentication information, is not registered in the authentication information table, the authenticating server 36 judges that the specific user who is operating the image reading/printing device 14 is not a legitimate user, and replies to the image reading/printing device 14 with information meaning that authentication has failed. However, if the combination of the user ID and the password, which is received as the user authentication information, is registered in the authentication information table and the authenticating server 36 judges that the specific user who is operating the image reading/printing device 14 is a legitimate user, the authenticating server 36 further searches the restricting information table by using the user ID as a key, and reads-out information extracted by that search (the restricting information corresponding to the specific user) from the restricting information table, and replies to the image reading/printing device 14 with the read-out restricting information corresponding to the specific user as well as information meaning that authentication has succeeded.

In the information adding processing (FIG. 2), when any information is received from the authenticating server 36, the routine moves on to step 56 where it is judged whether the authentication at the authenticating server 36 was successful, on the basis of whether or not information meaning that authentication has succeeded is included in the information received from the authenticating server 36. If the judgment is negative, the routine moves on to step 58 where error processing, such as displaying on the display section 22A a message giving notice that authentication has failed, or the like, is carried out, and the information adding processing ends. In this case, the addition of restricting information to the document for processing is not carried out.

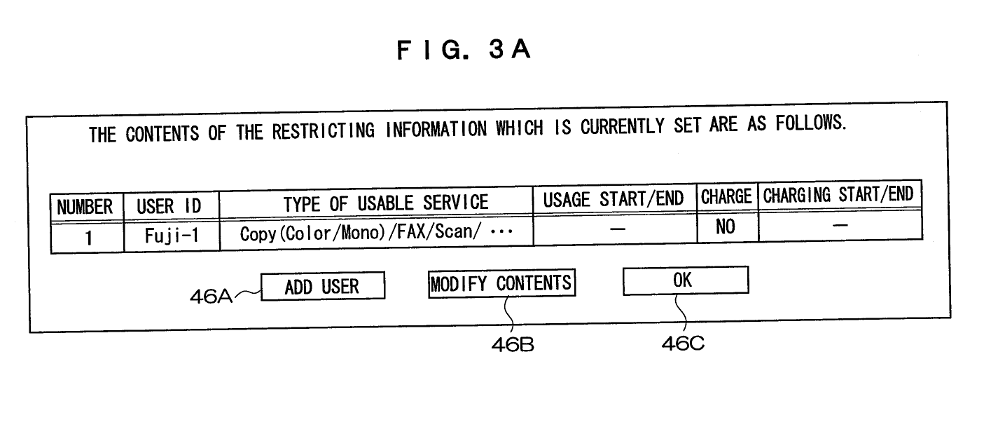

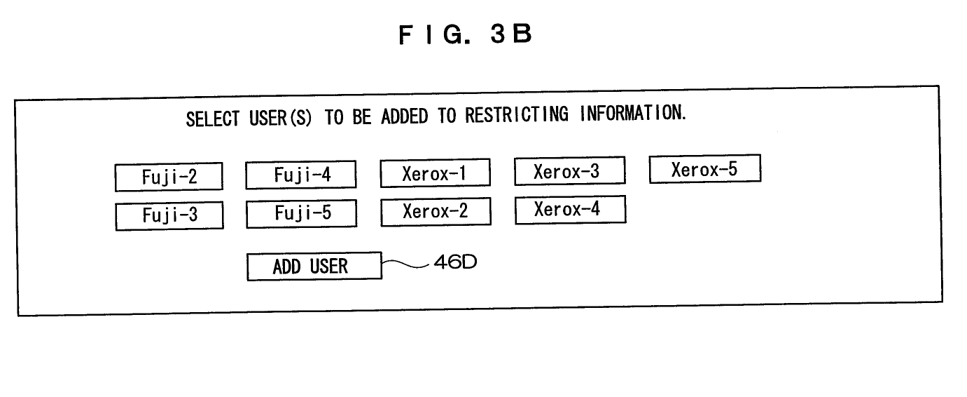

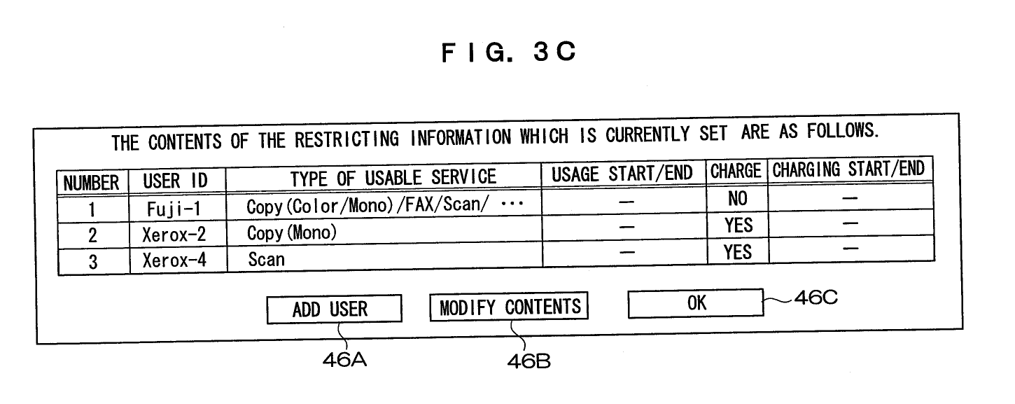

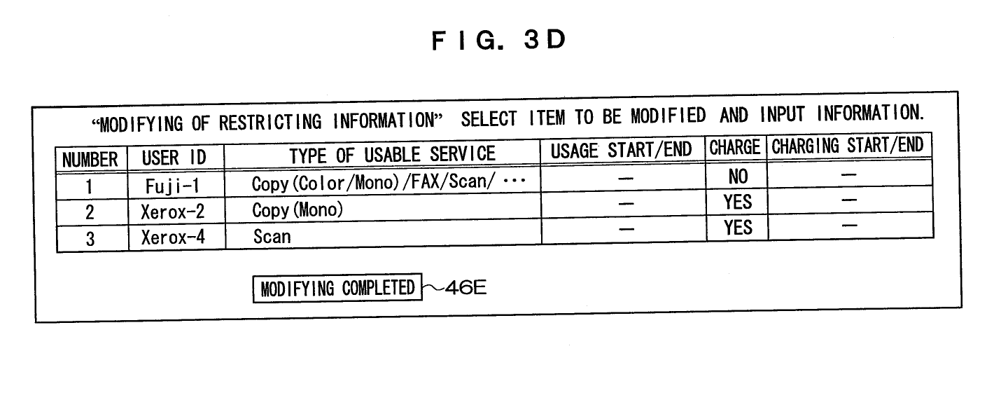

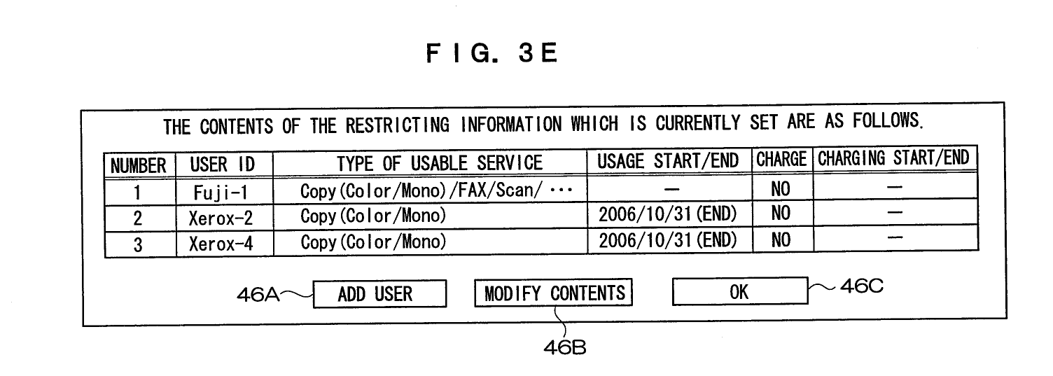

On the other hand, if the judgment in step 56 is affirmative, the routine moves on to step 60 where the restricting information corresponding to the specific user is extracted from the information received from the authenticating server 36, and the extracted restricting information is stored in the memory 16B as restricting information of the document for processing. In next step 62, the current contents of the restricting information of the document for processing, which is stored in the memory 16B, are displayed on the display section 22A. In this way, the screen shown in FIG. 3A as an example is displayed on the display section 22A. Note that, in the example shown in FIG. 3A, due to the addition of restricting information to the document for processing being instructed by the specific user, to whom the user ID “Fuji-1” is given, there is a state in which only the restricting information corresponding to the aforementioned specific user is set as the restricting information of the document for processing, with the contents only for the aforementioned specific user, that the processes of color copying, monochromatic copying, facsimile transmission, scanning, and the like of the document for processing are permitted, and that the execution of charging processing at the time of utilizing the services is set to “no”.

As shown in FIG. 3A (and in FIG. 3C and FIG. 3E which will be described later), the display fields “Usage Start/End (Date)” and “Charging Start/End (Date)” are provided, and a button 46A which instructs the addition of restricting information of another additional user to the restricting information of the document for processing, and a button 46B which instructs modifying of the contents of the restricting information of the document for processing, and a button 46C for confirmation of the contents of the restricting information of the document for processing, also are respectively provided at the screen which displays the contents of the restricting information of the document for processing. (The “Usage Start/End (Date)” and “Charging Start/End (Date)” will be described later.) After the current contents of the restricting information of the document for processing are displayed on the display section 22A in step 62, when any of the buttons 46A through 46C is selected, the routine moves on to step 64 where, on the basis of whether or not the selected button is the button 46C, it is judged whether or not confirmation of the contents of the restricting information of the document for processing is instructed. If the judgment is negative, the routine moves on to step 66 where, on the basis of whether or not the selected button is the button 46A, it is judged whether or not the addition of restricting information of other users to the restricting information of the document for processing is instructed.

In the state in which the contents of the restricting information are displayed on the display section 22A, if it is desired to allow processing of the document for processing also for other users whose user IDs are not displayed, the specific user, who instructed the addition of the restricting information to the document for processing, operates the operation section 22B and selects the button 46A. In this way, the judgment in step 64 is negative and the judgment in step 66 is affirmative and the routine moves on to step 68 where, among the user IDs which are registered in the user ID table, all of the user IDs, for which restricting information has not yet been set in the restricting information of the document for processing, are extracted, and are listed on the display section 22A as shown as an example in FIG. 3B. In next step 70, it is judged whether or not a user, for which restricting information is to be added to the restricting information of the document for processing, is selected, and step 70 is repeated until the judgment is affirmative.

As shown in FIG. 3B, a button 46D, which instructs the addition of the restricting information of a selected user, is provided at the screen which lists the user IDs for which restricting information has not yet been set. When this screen is displayed on the display section 22A, the specific user, who is instructing the addition of restricting information to the document for processing, operates the operation section 22B, and selects the user ID of a user who is an object of addition of restricting information, and thereafter, selects the button 46D. In this way, the judgment in step 70 is affirmative, and the routine moves on to step 72 where notice is given of the user ID selected by the specific user, and information requesting transfer of the restricting information corresponding to the user of that user ID is transmitted to the authenticating server 36.

Then, the authenticating server 36 which receives the aforementioned information searches the restricting information table by using the notified user ID as a key, and reads-out from the restricting information table the restricting information extracted by the search, and carries out processing which transmits the read-out restricting information. When the restricting information, which corresponds to the user of the user ID selected by the specific user, is received from the authenticating server 36 in this way, the routine returns to step 60 where the newly received restricting information is additionally stored (updated) in the memory 16B as restricting information of the document for processing. Thereafter, as shown in FIG. 3C as well, in next step 62, the current contents of the restricting information of the document for processing are re-displayed on the display section 22A.

Note that, in the example shown in FIG. 3C, due to above-described step 60 through step 72 being repeated plural times, the restricting information of the respective users whose user IDs are “Fuji-1”, “Xerox-2”, and “Xerox-4” are respectively set as restricting information of the document for processing. For the user whose user ID is “Fuji-1”, the processes of color copying, monochromatic copying, facsimile transmission, scanning, and the like of the document for processing are permitted, and the execution of charging processing at the time of using the services is set to “no”. On the other hand, for the user whose user ID is “Xerox-2”, only color copying and monochromatic copying of the document for processing are permitted, and, for the user “Xerox-4”, only scanning of the document for processing is permitted, and the execution of charging processing at the time of using the services is set to “yes” respectively.

Further, default values corresponding to standard usage conditions of each individual user are set as described above in the restricting information for each individual user registered in the restricting information table. However, depending on the type of the document for processing or the like, there are cases in which it is desired to change a portion of the contents of the restricting information per individual user which is set as the restricting information of the document for processing, such as, for example, for a user for whom color copying is not permitted under standard usage conditions, it is desired to allow color copying of the document for processing up to a given date, or, for a user for whom the execution of charging processing is set to “yes” under standard usage conditions, it is desired to set the execution of charging processing accompanying copying or the like of the document for processing to “no” up to a given date, or, when the document for processing is a confidential document, it is desired to prohibit copying and the like thereof up to the date when the confidentiality thereof is cancelled, or the like.

In this case, the specific user, who instructed the addition of restricting information to the document for processing, operates the operation section 22B and selects the button 46B. In this way, the judgments of steps 64, 66 are respectively negative, and the routine moves on to step 74 where, by judging whether or not the user ID which was inputted to the prior user authentication screen matches the pre-registered user ID of the administrator, it is judged whether or not the specific user who instructed the addition of restricting information to the document for processing is the administrator. If the judgment is negative, the routine moves on to step 76 where error processing, such as the display on the display section 22A of a message giving notice that persons other than the administrator cannot change the contents of the restricting information, or the like, is carried out, and thereafter, the routine returns to step 62. In this case, modifying of the contents of the restricting information of the document for processing is not carried out.

Further, if the judgment of step 74 is affirmative, the routine moves on to step 78 where the restricting information modifying screen shown in FIG. 3D as an example is displayed on the display section 22A. In this restricting information modifying screen, the contents of the respective items of “Types of Usable Services”, “Usage Start/End (Date)”, “Charge”, and “Charging Start/End (Date)” can be changed by moving a cursor to a displayed field and inputting the desired information. The restricting information modifying screen also has a button 46E for giving notice that the changing of the contents of the restricting information is completed. In next step 80, on the basis of whether or not the button 46E is selected, it is judged whether or not changing of the contents of the restricting information is completed, and step 80 is repeated until the judgment is affirmative.

While step 80 is being repeated, the specific user, who instructed addition of restricting information to the document for processing, operates the operation section 22B and changes the restricting information of the document for processing to the desired contents. Specifically, for example, for a user for whom color copying is not permitted under standard usage conditions, when it is desired to permit color copying of the document for processing up to a given date, the specific user operates the operation section 22B, and adds color copying to the “Types of Usable Services” of the aforementioned user among the restricting information of the document for processing, and carries out changing of the contents which set the usage end date in the “Usage Start/End (Date)”. Further, for example, for a user for whom the execution of charging processing under standard usage conditions is set to “yes”, when it is desired to set the execution of charging processing accompanying copying or the like of the document for processing to “no” up to a given date, the specific user operates the operation section 22B and carries out changing of the contents which set the charging start date in the “Charging Start/End (Date)” of the aforementioned user among the restricting information of the document for processing. Moreover, if the document for processing is a confidential document and it is desired to prohibit copying and the like thereof by the respective users up to the date when confidentiality of the document for processing is lifted, the specific user operates the operation section 22B and carries out changing of the contents which set the usage start date in the “Usage Start/End (Date)” of all of the users among the restricting information of the document for processing.

When the changing of the contents of the restricting information of the document for processing is completed as described above, the specific user operates the operation section 22B and selects the button 46E. In this way, the judgment in step 80 is affirmative and the routine moves on to step 82 where the restricting information of the document for processing, which is stored in the memory 16B, is modified in accordance with the information inputted by the specific user via the restricting information modifying screen. Thereafter, the routine returns to step 62, and, as shown in FIG. 3E as well as an example, the modified contents of the restricting information of the document for processing are re-displayed on the display section 22A. Note that, in the above description, only the administrator is allowed to change the contents of the restricting information of the document for processing, but the present invention is not restricted to the same, and the creator of the document for processing also may be permitted to change the contents of the restricting information of the document for processing.

Further, as is clear from comparison with the example shown in FIG. 3C, in the example shown in FIG. 3E, a state is shown in which the restricting information of the document for processing is changed to the contents that only color copying and monochromatic copying of the document for processing are permitted, and “Oct. 31, 2006” is set as the usage end date in “Usage Start/End (Date)”, and the execution of charging processing at the time of using services is set to “no”, for the users whose user IDs are “Xerox-2” and “Xerox-4” among the respective users whose user IDs are “Fuji-1”, “Xerox-2”, and “Xerox-4”. When the restricting information of the document for processing is the contents shown in FIG. 3E for example, in accordance with service usage control processing which will be described later, for the user whose user ID is “Fuji-1”, the processes of color copying, monochromatic copying, facsimile transmission, scanning, and the like of the document for processing are permitted indefinitely and charging processing is not executed when the services are used, and, on the other hand, for the users whose user IDs are “Xerox-2” and “Xerox-4”, only the processes of color copying and monochromatic copying of the document for processing are permitted up to “Oct. 31, 2006” which is the usage end date, and, even if color copying or monochromatic copying of the document for processing is carried out up to Oct. 31, 2006, charging processing is not executed.

Further, in the state in which the contents of the restricting information of the document for processing are displayed on the display section 22A, when the operation section 22B is operated and the button 46C is selected due to the contents of the restricting information of the document for processing being judged to be proper by the specific user, the judgment in step 64 is affirmative and the routine moves on to step 84. By judging that the document for processing is set at the image reading section 18, or that the storage location of the data of the document for processing is designated, it is judged in step 84 whether or not the document for processing exists in a state of being printed on a recording sheet (i.e., whether or not the document for processing is a paper manuscript). If the judgment is affirmative, in step 86, document reading processing is carried out in which the document for processing (the paper manuscript) which is set at the image reading section 18 is read by the image reading section 18, and the image data outputted from the image reading section 18 accompanying this reading is temporarily stored in the memory 16B. Thereafter, the routine moves on to step 88. Further, if the judgment in step 84 is negative, the routine skips step 86 and moves on to step 88.

In step 88, the image data obtained by the document reading processing of step 86 (when the document for processing is a paper manuscript), or the data of the document for processing which is stored in a storage location designated by the specific user (when the document for processing is stored as data), is converted into data for printing which is of a predetermined format for printing the document for processing by the printing processing section 20 (e.g., bitmap data or data of another format). In next step 90, the restricting information, whose contents were fixed by the above-described processing, is converted into mark information, which expresses this restricting information by an optically-readable mark. Note that a two-dimensional barcode is suitable for the optically-readable mark which expresses the restricting information (more specifically, a QR code or the like), but another mark may be used. For example, if the amount of data of the restricting information is small, a one-dimensional barcode or the like can be applied. Further, data for causing the aforementioned mark which expresses the restricting information to be printed onto a recording sheet by the printing processing section 20 (e.g., bitmap data or data of another format or the like) can be used as the mark information.

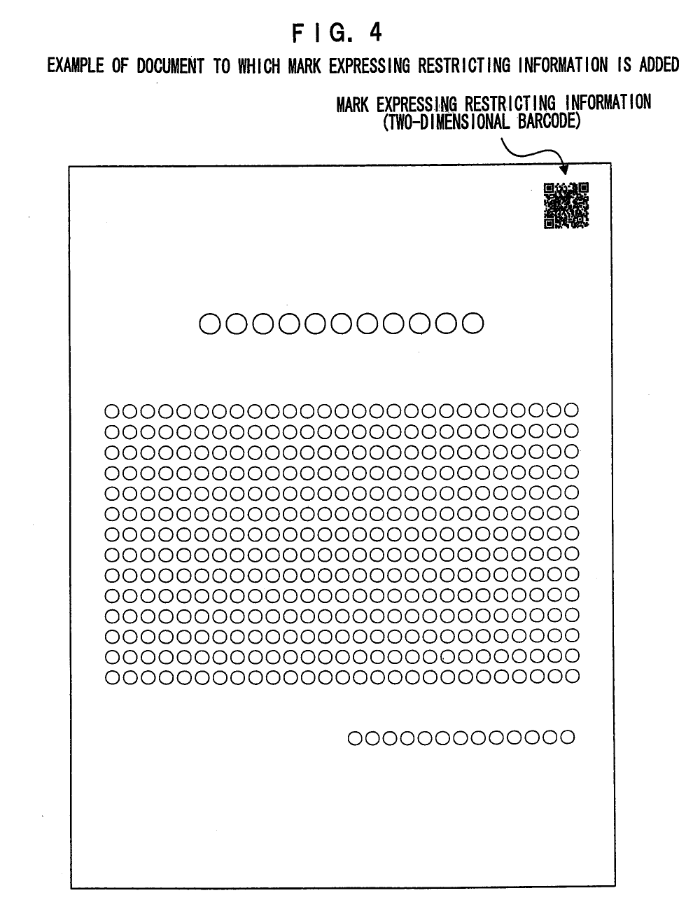

In next step 92, the mark information obtained by the processing of step 90 is embedded in the data for printing of the document for processing, such that the mark expressing the restricting information also is simultaneously printed onto the same recording sheet when the document for processing is printed onto the recording sheet by the printing processing section 20. Then, in step 94, the data for printing of the document for processing, in which the mark information is embedded, is transferred to the printing processing section 20, and the information adding processing ends. In this way, as shown in FIG. 4 as an example, the document for processing, to which is added the mark which expresses the restricting information (in FIG. 4, a two-dimensional barcode is shown as an example of this mark), is printed onto a recording sheet by the printing processing section 20.

Note that reading of the mark is easier when the mark is printed at a uniform position on the document for processing. However, depending on the contents of the document for processing, there is the possibility that a problem, such as the printed mark will overlap characters or the like within the document for processing, or the like, will arise. Therefore, at the time of embedding the mark information into the data for printing of the document for processing in step 92, it is preferable to search for the margin portions within the document for processing (the portions at which characters or the like are not printed), and to embed the mark information in the data for printing of the document for processing such that the mark is printed, in the document for processing, at a margin portion at which overlapping with characters or the like can be avoided.

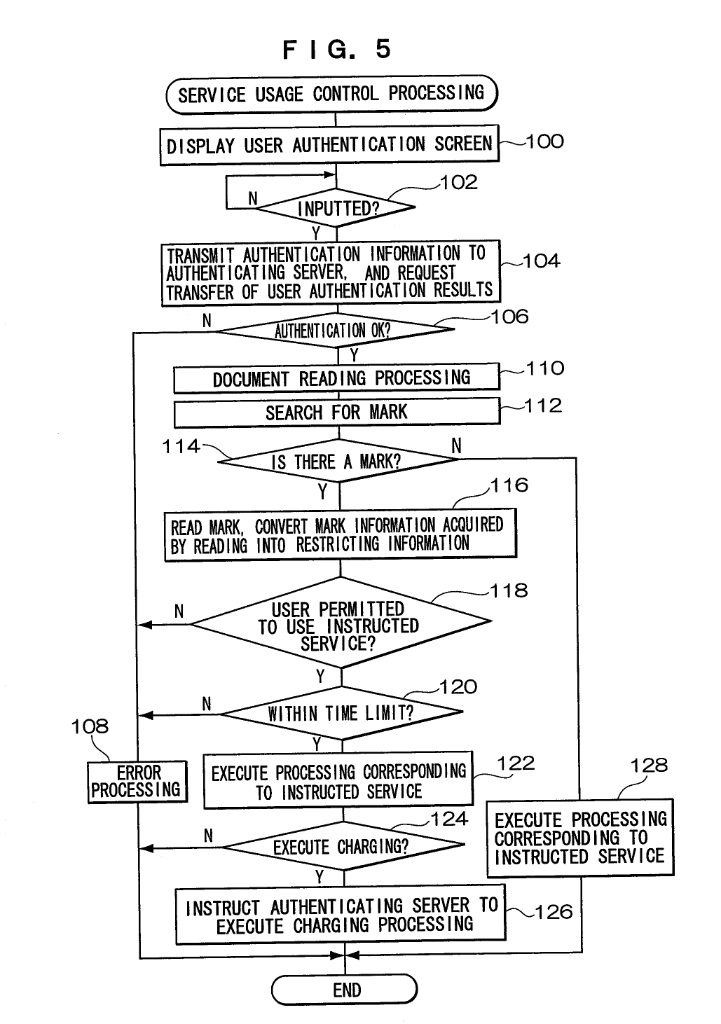

Then, in a case in which the document for processing which is in a state of being printed on a recording sheet (the paper manuscript) is set at the image reading section 18, and thereafter, an unspecified user requests the image reading/printing device 14 for usage of a service which that image reading/printing device 14 provides (color copying or monochromatic copying, facsimile transmission, scanning, or the like of the document for processing), a program for carrying out service usage control processing is executed among the information adding/usage control programs by the CPU 16A of the main body control section 16 of the image reading/printing device 14. This service usage control processing which is thereby realized by the main body control section 16 will be described hereinafter with reference to FIG. 5.

In this service usage control processing, first, in step 100, by displaying the user authentication screen on the display section 22A, the user who requested service usage from the image reading/printing device 14 (hereinafter called “service user”) is requested to input user authentication information. In next step 102, it is judged whether or not user authentication information has been inputted by the service user, and step 102 is repeated until the judgment is affirmative. When the user authentication screen is displayed on the display section 22A, the service user operates the operation section 22B and inputs his/her own user authentication information (user ID and password). When the user authentication information is inputted, the judgment in step 102 is affirmative, and the routine moves on to step 104 where the user authentication information inputted by the service user is transmitted to the authenticating server 36, and information, which requests the execution of authentication processing and the transfer of the authentication processing results, also are transmitted to the authenticating server 36.

In this way, authentication processing, which judges whether or not the service user is a legitimate user, is carried out at the authenticating server 36, and information expressing the results of the authentication processing is transmitted from the authenticating server 36 to the image reading/printing device 14. In the service usage control processing (FIG. 5), when any information is received from the authenticating server 36, the routine moves on to step 106, and it is judged whether or not the authentication results, which are expressed by the information received from the authenticating server 36, are that authentication has been successful. If the judgment is negative, the routine moves on to step 108, and error processing, such as displaying on the display section 22A a message giving notice that authentication has failed, or the like, is carried out, and the service usage control processing ends. In this case, the provision of the instructed service to the service user is not carried out.

On the other hand, if the judgment in step 106 is affirmative, the routine moves on to step 110, and document reading processing is carried out in which the document for processing (the paper manuscript) set at the image reading section 18 is read by the image reading section 18, and the image data outputted from the image reading section 18 accompanying this reading is temporarily stored in the memory 16B. In next step 112, by searching whether or not there exists, within the image expressed by the image data obtained by the document reading processing of step 110, an image portion corresponding to a mark which expresses restricting information, it is investigated whether or not a mark expressing restricting information is added to the document for processing.

When the searching processing of step 112 ends, the routine moves on to step 114 where it is judged whether or not a mark expressing restricting information was discovered by the searching processing of step 112. If this judgment is affirmative, it can be judged that the document for processing is a document to which (a mark expressing) restricting information is added. Therefore, the routine moves on to step 116 where the mark added to the document for processing is read, and the mark information obtained by this reading is converted into the restricting information which the mark expresses. In next step 118, the restricting information obtained by the processing of step 116 is referred to, and it is judged whether or not, in this restricting information, the service user is permitted to use the service instructed by the service user.

If the user ID of the service user is not set in the restricting information, or if the user ID of the service user is set in the restricting information but the instructed service is not set in the restricting information as a service which the service user can use, the aforementioned judgment is negative, and the routine moves on to step 108 where error processing, such as displaying on the display section 22A a message giving notice that usage of the instructed service is not permitted, or the like, is carried out, and the service usage control processing ends. In this case, providing of the instructed service to the service user is not carried out.

Further, if the user ID of the service user is set in the restricting information and the instructed service also is set in the restricting information as a service which the service user can use, the judgment in step 118 is affirmative and the routine moves on to step 120 where it is judged whether a usage start/end (date) is set for the service user in the restricting information, and, if a usage start/end (date) is set, it is judged, on the basis of the set usage start/end (date), whether or not the current date is within the time period in which usage is permitted. When a usage start/end (date) is set in the restricting information for the service user and the current date falls outside of the usage permitted time period which the set usage start/end (date) stipulates, the judgment in step 120 is negative, and the routine moves on to step 108 where error processing, such as displaying on the display section 22A a message giving notice that the current date is outside of the usage permitted time period, or the like, is carried out, and the service usage control processing ends. In this case as well, the provision of the instructed service to the service user is not carried out.

On the other hand, if a usage start/end (date) is not set in the restricting information for the service user, or, if a usage start/end (date) is set in the restricting information for the service user but the current date is within the usage permitted time period which the set usage start/end (date) stipulates, the judgment in step 120 is affirmative, and the routine moves on to step 122 where processing corresponding to the service instructed from the service user (processing corresponding to any of color copying or monochromatic copying, facsimile transmission, scanning, or the like) is executed.

In next step 124, the restricting information is referred to, and, for the service user, it is judged whether or not information, which instructs execution of charging processing accompanying service usage, is set in the restricting information. If execution of charging processing at the time of service usage is set to be “yes” for the service user in the restricting information, or if execution of charging processing at the time of service usage is set to be “yes” for the service user in the restricting information and a charging start/end (date) also is set in the restricting information and the current date is within the charging time period which the set charging start/end (date) stipulates, the aforementioned judgment is affirmative, and the routine moves on to step 126 where the authenticating server 36 is notified of the user ID of the service user and the type of the service provided to the service user and is instructed to execute charging processing, and the service usage control processing ends. In this way, on the basis of the notified user ID and service type, the authenticating server 36 carries out charging processing that updates the corresponding charging information stored in the charging information table.

On the other hand, if execution of charging processing at the time of service usage is set to be “no” for the service user in the restricting information, or if execution of charging processing at the time of service usage is set to be “yes” for the service user in the restricting information but a charging start/end (date) also is set and the current date falls outside of the charging time period which the set charging start/end (date) stipulates, the judgment of step 124 is negative, and step 126 is skipped and the service usage control processing ends. In this case, charging processing by the authenticating server 36 is not carried out.

Further, if the document for processing is a document to which (a mark expressing) restricting information is not added, the judgment in step 114 is negative, and the routine moves on to step 128 where processing corresponding to the service instructed by the service user is carried out, and, thereafter, the service usage control processing ends. Note that, also in this step 128, the following may be employed: the corresponding restricting information (restricting information which is registered in the restricting information table and in which are set default values which correspond to standard usage conditions) is acquired from the authenticating server 36 on the basis of the user ID of the service user, and processing corresponding to the instructed service is carried out only when usage of the instructed service is permitted in the acquired restricting information.

Note that the screen images shown in FIGS. 3A through 3E are merely examples, and the screen layout and the like when the contents of the restricting information are displayed at the display unit are not limited to the examples shown in FIGS. 3A through 3E, and may, of course, be changed within a scope which does not depart from the present invention.

Further, an aspect is described above in which the authentication information table, the restricting information table, and the charging information table are held in the authenticating server 36, and the authenticating server 36 carries out authentication processing and charging processing. However, the present invention is not limited to the same. Some or all of the information registered in the aforementioned respective tables, or information similar to such information, may be stored in a storage unit of a device which functions as a document processing device, and the authentication processing and charging processing may be carried out at that device.

Moreover, an aspect is described above in which the restricting information registered in the restricting information table is used as a template, and, by changing as needed, restricting information of a document for processing is generated. However, the present invention is not limited to the same, and, when addition of restricting information to the document for processing is instructed, the restricting information of the document for processing may be set from the start (without using a template or the like) by the user who instructed the addition of the restricting information. In this aspect, the restricting information table may be omitted.

In the above description, the restricting information of the document for processing is a data structure in which the charge instructing information corresponds to the charge instructing information, the usage start/end (date), and the charging start/end (date) can be set per user. However, the present invention is not limited to the same, and, for each individual user, the aforementioned charge instructing information, usage start/end (date), and charging start/end (date) may respectively be set per individual service set as a usable service in the restricting information.

It may be arranged such that, when embedding the mark information expressing the restricting information into the printing data of the document for processing, if there is restraint data in the document, for clearly expressing a restraint when the document being processed is copied, or in the read data when the document for processing is optically read, such as “Do Not Copy” or “Electronic Reading Prohibited” or the like, and that restraint is also superposed on the printing data, and the document for which service usage is instructed by a user, such as copying, facsimile transmission, scanning or the like, is a document to which a mark expressing restricting information is added, then it is only possible to carry out processing which erases the restraint from the obtained read-in image data when usage of the user instructed service is permitted in the restricting information, and to carry out the processing corresponding to the instructed service (e.g., printing onto a recording sheet for copying, transmission of the image data for facsimile transmission, storing of the image data for scanning), by using the image data which has undergone such erasing processing.

Further, an aspect is described above in which the image reading/printing device 14 is made to function as a document processing device, but the present invention is not limited to the same. For example, the addition of (a mark expressing) restricting information to a document whose data is stored in a predetermined storage location may also be executed at the client terminal 26, and also when a reading unit, such as a scanner or the like, and a printing unit, such as a printer or the like, are connected either directly or via the network 12 to the client terminal 26, as shown by the dashed line in FIG. 1, a program for causing the client terminal 26 to function as a document processing device may be installed in the HDD 26C of the client terminal 26, and the client terminal 26 may be made to function as a document processing device by causing the reading unit to function as the image reading section 18 in the above-described aspect (the aspect of making the image reading/printing device 14 function as a document processing device) and causing the printing unit to function as the printing processing section 20 in the above-described aspect.

Moreover, an aspect is described above in which the information adding/usage control programs, which correspond to document processing programs, are stored in advance (installed) in the HDD 16C of the image reading/printing device 14. However, the programs may be provided in the form of being recorded on a recording medium such as a CD-ROM or a DVD-ROM or the like.

What is claimed is:

1. A document processing device comprising:
an acquiring unit that acquires restricting information that stipulates, per user, whether execution of processing relating to a document is permitted or restricted;
a converting unit that converts the restricting information acquired by the acquiring unit into an optically-readable restricting information image; and
an embedding unit that embeds the restricting information image into information of the document, such that the restricting information image is also printed when the document is printed.

2. The document processing device of claim 1, wherein the restricting information acquired by the acquiring unit is information stipulating, per user, whether execution is permitted or restricted with respect to a plurality of types of processing among processes relating to the document, such as color copying of the document, monochromatic copying of the document, reading-in of the document, facsimile transmission of the document, and the like.

3. The document processing device of claim 1, further comprising a modifying unit that modifies the restricting information acquired by the acquiring unit, in accordance with instruction information that instructs modification of contents of the restricting information.

4. The document processing device of claim 2, further comprising a modifying unit that modifies the restricting information acquired by the acquiring unit, in accordance with instruction information that instructs modification of contents of the restricting information.

5. The document processing device of claim 3, further comprising an embedding-instructing-user identifying unit that identifies a user who instructs embedding of the restricting information image into the document, wherein,
when a user identified by the embedding-instructing-user identifying unit is a user who is registered in advance, the modifying unit carries out modification of the restricting information in accordance with the instruction information.

6. The document processing device of claim 4, further comprising an embedding-instructing-user identifying unit that identifies a user who instructs embedding of the restricting information image into the document, wherein,
when a user identified by the embedding-instructing-user identifying unit is a user who is registered in advance, the modifying unit carries out modification of the restricting information in accordance with the instruction information.

7. The document processing device of claim 3, wherein, when addition of charge instructing information, which stipulates whether or not charging processing is to be carried out accompanying execution of the processing relating to the document, is instructed by the instructing information, the modifying unit carries out processing of adding the charge instructing information to the restricting information.

8. The document processing device of claim 4, wherein, when addition of charge instructing information, which stipulates whether or not charging processing is to be carried out accompanying execution of the processing relating to the document, is instructed by the instructing information, the modifying unit carries out processing of adding the charge instructing information to the restricting information.

9. The document processing device of claim 5, wherein, when addition of charge instructing information, which stipulates whether or not charging processing is to be carried out accompanying execution of the processing relating to the document , is instructed by the instructing information, the modifying unit carries out processing of adding the charge instructing information to the restricting information.

10. The document processing device of claim 6, wherein, when addition of charge instructing information, which stipulates whether or not charging processing is to be carried out accompanying execution of the processing relating to the document, is instructed by the instructing information, the modifying unit carries out processing of adding the charge instructing information to the restricting information.

11. A document processing system comprising:
an acquiring unit that acquires restricting information that stipulates, per user, whether execution of processing relating to a document is permitted or restricted;
a converting unit that converts the restricting information acquired by the acquiring unit into an optically-readable restricting information image;
an embedding unit that embeds the restricting information image into information of the document, such that the restricting information image is also printed when the document is printed;
a user identifying unit that identifies a user who instructs execution of the processing relating to the document which is printed after the restricting information image is embedded by the embedding unit;
a reading unit that optically reads-in the restricting information image printed on the document; and
a control unit that judges whether or not execution of the processing relating to the document which is instructed by the user identified by the user identifying unit, is permitted in the restricting information expressed by the restricting information image read by the reading unit, and, if execution of the instructed processing is not permitted, the control unit restricts execution of the instructed processing.

12. A storage medium storing a computer program that causes a computer to perform a function comprising:
acquiring restricting information that stipulates, per user, whether execution of processing relating to a document is permitted or restricted;
converting the restricting information acquired by the acquiring unit into an optically-readable restricting information image; and
embedding the restricting information image into information of the document, such that the restricting information image is also printed when the document is printed.

13. A document processing device comprising:
an acquiring unit that acquires restricting information that stipulates, per user, whether execution of processing relating to a document is permitted or restricted, the stipulated processing is with respect to a plurality of types of processing among processes relating to the document, such as color copying of the document, monochromatic copying of the document, reading-in of the document, facsimile transmission of the document, and the like;
a converting unit that converts the restricting information acquired by the acquiring unit into an optically-readable restricting information image;
an embedding unit that embeds the restricting information image into information of the document, such that the restricting information image is also printed when the document is printed; and
a modifying unit that modifies the restricting information acquired by the acquiring unit, in accordance with instruction information that instructs modification of contents of the restricting information.
